(19) United States
(12) Patent Application Publication
(10) Pub. No.: US 2026/0125127 A1
(43) Pub. Date: May 7, 2026

(54) Stabilizing system for a vehicle and a vehicle comprising such a stabilizing system

(71) Applicant: Yoel Avisror, Gümligen (CH)

(72) Inventor: Yoel Avisror, Gümligen (CH)

(21) Appl. No.: 19/439,909

(22) Filed: Jan. 5, 2026

Related U.S. Application Data
(63) Continuation of application No. PCT/EP2024/068913, filed on Jul. 4, 2024.

(30) Foreign Application Priority Data
Jul. 4, 2023 (CH) CH000720/2023

(51) Int. Cl. B62H 1/12; B62J 45/20; B62J 45/412; B62J 45/415

(52) U.S. Cl. CPC B62H 1/12; B62J 45/20; B62J 45/412; B62J 45/4151

(57) ABSTRACT

Vehicles, in particular human-powered vehicles, more specifically a stabilizing system for a vehicle and a corresponding vehicle with such a stabilizing system.

### CROSS-REFERENCE TO RELATED APPLICATION

This application is a bypass continuation in part of PCT/EP2024/068913, filed on Jul. 4, 2024, and published as WO 2025/008474 on Jan. 9, 2025, in English and which claims priority to Swiss application No. CH000720/2023 filed on Jul. 4, 2023, the contents of each being incorporated herein in their entireties.

### FIELD OF THE INVENTION

The present invention relates generally to the field of vehicles, in particular to the field of human-powered vehicles. Examples of such vehicles comprise namely bicycles or similar devices, in particular with an electrical motorization (so called e-bikes). This invention is however not limited to any particular device, and it can generally be implemented in any suitable vehicle. More specifically, the present invention relates to a novel stabilizing system for a vehicle and a vehicle comprising such a stabilizing system.

### BACKGROUND

It is generally known that bicycles lack lateral stability when stationery or when inertial forces act obliquely to the upright axis of the bicycle and that they can normally only remain upright when moving forward and the gyroscopic effect of the turning wheels provides sufficient stability against tilting.

Experimentation and mathematical analysis have shown that a bicycle stays upright when it is steered to keep its centre of mass over its wheels. Several factors, including geometry, mass distribution, and gyroscopic effects contribute to varying degrees to the self-stability of the bicycles. In particular, when a bicycle is used by adults who need to carry children and/or luggage on an everyday basis in an urban environment, this stability matter becomes a very an important issue that can be a limiting factor to replacing the use of cars by bicycles and thus contribute to the ecological traffic transition. It is namely known that bicycles are not stable and are not always safe to ride. They tend to slip in various situations and under difficult circumstances. In addition, the speed and weight of the load upon the bicycles tend to increase when users use them as a substance for conventional transportation. In view thereof, bicycles have the most vulnerable users due to their construction. Increasing the daily cycling distance results in highly severe accidents and more deaths while the market's demand grows exponentially.

The crash rate is unfortunately 3 times higher than for cars per 1'000 km. The costs of bicycle injuries and deaths from crashes typically exceed $100 billion worldwide. So is e.g., the risk of a deadly accident by bicycle in Switzerland estimated to be around 11.8 times higher than by car, according to the statistical info from the Swiss Federal Roads Office.

### SUMMARY

There is therefore a need for a solution to support lateral stability of bicycles and side impact without the need of the rider to touch the ground. In addition, there is also a need to solve the problem that steering of a bicycle on uneven surfaces and/or on bad turf conditions and with low gripping can result in falling. In addition, there is also a need for a proactive support when exceeded leaning occurs but said support needs to be adaptable to different driving conditions, in particular to high-speed conditions and low speed conditions. However, a system providing such support should only engage when support is actually required and be as little noticeable to the driver as possible when no support is required as to not impair the known advantages of bicycles, e.g., manoeuvrability.

These and other problems are solved by means of the present invention that comprises a proactive stability control for a vehicle, in particular for a bicycle, more specifically for an e-bicycle. More particularly, the present invention comprises a side support solution for high saddle pedaling transport that is based on 1, 2 or more additional or auxiliary wheels placed sideways from the main wheels of the vehicle and that can move either simultaneously or individually in various situations with various degrees of freedom in three different axes (X, Y and Z), that means: up and down, forward and backward, laterally (closer to the vehicle and more away from the vehicle) or changing the direction with respect to the bicycle, i.e. changing the angle α with respect to the central plane of the vehicle. It is important to mention that this option does not rule out challenging sporty riding for the users and allows riding in a new riding experience dimension.

Therefore, the object of the invention is specifically obtained by a stabilizing system for a vehicle, comprising at least one auxiliary wheel able to change position with respect to the vehicle by moving up and down (y-axis), left and right (x-axis), closer to the vehicle or more away from the vehicle (z-axis) or by changing the angle with respect to the central plane of the vehicle such that each auxiliary wheel is able to engage with or disengage from the ground, wherein the change of the position and/or the engagement with and/or disengagement from the ground is controllable by one or more control modules configured to evaluate one or more control parameters and to determine, based on an assessed operating condition of the bicycle, whether and how the auxiliary wheel is actuated. In this stabilizing system, each auxiliary wheel is able to change position with respect to the vehicle and/or engage with or disengage from the ground in an independent manner.

Moreover, this side support device can, in addition to the auxiliary wheels comprise a number of different elements, namely: one or more gearing mechanisms, linkage, wishbones, ball joints, hydraulic rods, momentum levers transmitters, springs, cogs, chains, cables, different sensors, in particular inertial sensors, and/or electronic controllers. Of course, the invention is not limited to a particular combination of components but extends to various combinations, as long as they share the common inventive concept. In the stabilizing system according to an embodiment of the invention, the change of the position and/or the engagement with and/or disengagement from the ground is controllable by one or more control modules using control parameters that can be either detected and processed by the controller or input by the driver of the vehicle. Particularly suitable control parameters include the cadence or the cycle rate of pedaling, presence of skidding, braking, any type of mechanical malfunction, the direction of pedaling, tilting angle α of the vehicle, speed of the vehicle, any change thereof or any combination thereof. For example, control parameters comprise sensor-derived inputs including cadence or cycle rate of pedaling, presence of skidding, braking, mechanical malfunction, direction of pedaling, tilting angle α of the vehicle, speed of the vehicle, or combinations thereof, wherein said parameters are processed individually or in combination and selectively weighted depending on the detected riding condition. The auxiliary wheels engage and disengage in a way to eliminate the impact when each side touches the ground. Moreover, the wheels find the way to overcome the spinning speed from the “aviation level”to touch ground.

Moreover, the proactive system does not rule out further integration on or with other vehicles or modes of conveyance and especially on bicycles as a subsystem to be mounted separately on any other platform. Customizable Basic Platforms for other bike products (not if monocoque) and as a whole platform with fully enclosed design. Moreover, the systems described herein can be used as a retrofit and/or aftermarket assembly for use and/or easily adaptable for use with bicycles of various construction and geometry (e.g., dimension, size, design, construction, intended use such as road, mountain, electric, adult, children's etc.,) without introduction of new hardware or software components and/or deviating from the function described herein.

The movement of the auxiliary wheels may depend on several factors, and parameters, which can be sensed using various sensors and processed by controllers in the function of the needs. Essentially, the auxiliary wheels may have three different functionalities or controlling options:
1. Pedaling: A pedaling system contributes to engaging the proactive support system of the bicycles by sensing the pedal cadence, the riding speed and/or angle output. In particular, when the cadence of pedaling or the riding speed increases, the auxiliary wheels can be lifted up as their function of stabilizing is no longer needed. Pedaling cadence and riding speed are evaluated by the control module as part of an overall stability assessment, wherein auxiliary wheel engagement is selectively determined rather than triggered by a fixed cadence or speed threshold. The up and down movement of the auxiliary wheels can be performed by means of electronic drive units or by means of a mechanical connection of the pedaling system to the auxiliary wheels.

The threshold defining the exact cadence of pedaling that will result in lifting or lowering of the auxiliary wheels can be chosen based on various parameters and can also be adjusted for each user in an individual manner.
2. Turning: When momentum about the x-axis is applied on the handlebar (for turning left or right), this momentum is coupled and transmitted mechanically to the proactive support system and the directional steering is copied to the auxiliary wheels to support a smooth curving. In case of turning at low speed, the turn of the vehicle is governed by the relative movement of the handle bar, which is transmitted to one or multiple main and/or auxiliary wheels (steering). The auxiliary wheels will be engaged with the ground. In this context, it is It is very important to mention that the auxiliary wheels have independent movements, steering and suspension and that each of them can also be driven at different speeds (e.g. the inner wheel in a curve will turn at a higher speed than the outer wheel). Also important is to mention that the auxiliary wheels are coupled in such a manner as to mimic the direction of the main steering wheel or handlebar of the vehicle to avoid skidding.

In addition, when turning at high speed, the turn of the vehicle is governed by a relative movement of the vehicle about the y-axis (leaning), although steering can be present as well. In this case the auxiliary wheels will in general not be engaged (unless the situation indicates the opposite) with the ground and the vehicle can be turned in the “regular” way. However, in case of a turn at high velocity and an involuntary side tilt, one of the auxiliary wheels can be driven to lower and engage with the ground in order to support the turning of the vehicle and add to the stability. 3.Braking: braking is provided as an input to the control module; wherein auxiliary wheel engagement is selectively actuated based on braking intensity in combination with at least one additional stability-related parameter. Of course, the auxiliary wheels have independent braking, which means that when braking is engaged on both the main wheels and the auxiliary wheels, the overall braking force is higher than when the vehicle enters the braking procedure without the auxiliary wheels.

In general, it is to be said that the invention foresees that the auxiliary wheels engage simultaneously or individually and in various situations, namely:
1. When reducing the cadence (or the cycle rate) of pedaling, that means when slowing down or when descending from the bicycle, as already mentioned above.
2. When sudden skidding occurs (caused by any reason).'
3. When braking, in order to stabilize the vehicle and increase the braking force or intensity.
4. When any type of mechanical fault has been detected and in order to prevent the user from falling down from the bicycle.
5. When desired by the users.

However, the stabilizing system according to the invention can include at least two operating states corresponding to different riding conditions, wherein transitions between said operating states are dynamically determined based on evaluated sensor data. The different operating states may each be provided with a set of control parameters employed to control the engagement and/or disengagement of the at least one auxiliary wheel for the corresponding operating state. By doing that, the stabilizing system may for example lower an auxiliary wheel to engage with the ground at a given tilt angle α in the low-speed mode but may not do so in the high-speed mode for the same given tilt angle α. Other parameters, e.g., pedaling cadence, presence of skidding, and so forth, may also be used to distinguish the first and second control mode.

The invention foresees a safe position being characterized in that each auxiliary wheel is engaged with the ground and the angle of each auxiliary wheel with respect to the central plane of the vehicle is 0°. The stabilizing system according to the invention may assume this safe position based on any control parameter but in particular, based on the interaction of the driver with the stabilizing system.

In addition to the automatic engagement of the auxiliary wheels, the invention foresees the option of a manual engagement using a lever, a button, or any other similar device accessible by the driver.

In an embodiment of the invention, the stabilizing system comprises means to limit the range of motion of the at least one auxiliary wheel along the y-axis and/or x-axis and/or z-axis and/or to limit the change in angle with respect to the central plane of the vehicle such that a minimum distance between the at least one auxiliary wheel and any part of the vehicle frame is maintained. In this way, even when taking a sharp turn and/or putting a majority of the vehicle's weight onto one auxiliary wheel for any reason and thus compressing the suspension connected to said auxiliary wheel, sufficient clearance between the auxiliary wheel and any part of the frame is maintained so that the auxiliary wheel is not exposed to any involuntary braking.

In an advantageous way, the invention may comprise at least one releasable coupling mechanism, preferably a clutch, to releasably couple the steering movement of a vehicle to the stabilizing system. By employing such a coupling mechanism, the stabilizing system is decouplable and any vehicle comprising such a stabilizing system may be usable in a regular manner as if no stabilizing system were present. Such a coupling mechanism could be present in form of a clutch, preferably an electric clutch, but is not limited to a clutch or an electric clutch.

The invention also foresees an optional function of reverse pedaling, i.e., the possibility of turning the pedals in a backward direction and transmitting this reverse pedaling to a movement of the vehicle in a backward direction. In this case, this reverse pedaling can also be a trigger for the engagement of the auxiliary wheels in order to add to the stability of the bicycle while moving backward, knowing that this movement will generally be at lower speed.

The invention also foresees a vehicle which comprises the stabilizing system according to the invention, in particular a bicycle.

Moreover, the invention also foresees a closed, semi-closed or convertible vehicle cabin which will add to the safety and comfort of the user.

The whole bicycle can have a safety cockpit and shell design. Together with the stabilizing system of the invention, such a cabin creates a highly secure and safe vehicle. However, it is to be mentioned that the cabin is an optional feature and the stabilizing system as disclosed in this application can also be implemented on a vehicle that does not comprise a cabin.

A vehicle according to this invention may comprise at least one drive unit to manipulate the vehicle's steering and/or manipulate the vehicle's drivetrain, in particular its propulsion and its braking, and at least one control unit to control said at least one drive unit. This will enable so-called drive-by-wire, steer-by-wire and/or brake-by-wire operating modes which enable further degrees of freedom for the design of such a vehicle, especially when it is an e-bicycle.

A vehicle according to the invention, in particular when having a semi-closed or closed cabin, may comprise a crank set wherein the crank arm is mounted eccentrically to the crank wheel with respect to the axis of rotation of the crank wheel. This feature allows the cabin of the vehicle to be closer to the axis of rotation of the crank wheel and thus allows for e.g. an increased clearance between the ground and the cabin while maintaining the axis of rotation of the crank set in a position which is ergonomic for the driver.

In case the invention is implemented on an e-bicycle, electric energy from a battery can support the ease of movement for the user by its transmission to an electro-motor. Battery charging will be possible using solar energy transmission from the bicycle roof and power plug charging. The battery might be portable to enable a charging option in a flat/room distanced from the bicycle. Next, to support easy bicycle movement, the electric energy will be used to launch the start of the balancing assistance and keep it active during substantially zero (0) velocities occurring during the launching and landing phases of the bicycle. The balancing assistance will use steering and pedaling principles to react with a stabilization landing gear without engaging the user's feet to ground contact with the bicycle during its use and is intended to store energy in an intermediate fashion.

The intermittent stored energy will be released for kinetic movement of the vehicle if required, and if not in conflict with its primary functionality of balancing the vehicle. Regenerative braking may be implemented as a further source of energy recovery. The balancing system is designed and integrated in a way that supports the silent movement of the bicycle.

In addition, further charging of the battery is foreseen by direct charging through solar energy, regenerative braking, and/or power plug.

As aspect of the present disclosure relates to an adaptive stabilizing system for a bicycle comprising at least one auxiliary wheel mounted to a location positioned on a front of the bicycle near the steering device of the bicycle and configured to move between positions for use with respect to the bicycle; and one or more control modules operably coupled to the at least one auxiliary wheel and configured to actuate movement of the at least one auxiliary wheel between positions for use and wherein the one or more control modules are responsive to automatic or manual inputs, and wherein the at least one auxiliary wheel is mounted to the bicycle and configured to move between positions by moving up and down along a Y-axis, left and right along an X-axis, closer to the bicycle or away from the bicycle along a Z-axis or by changing an angle along one of the Y, X, or Z axes with respect to a central plane of the bicycle such that the at least one auxiliary wheel is configured to automatically or manually adapt to engage or disengage a ground surface during use of the bicycle for selected stabilization of the bicycle during use or when stationary.

In one or more embodiments the adaptive stabilizing system comprises two or more auxiliary wheels and wherein each auxiliary wheel of the two or more auxiliary wheels is independently operably to change position with respect to the bicycle and/or engage with or disengage the ground surface.

In one or more embodiments the change of the position of the at least one auxiliary wheel is controllable by one or more control modules configured to evaluate one or more control parameters and to determine, based on an assessed operating condition of the bicycle, whether and how the auxiliary wheel is actuated.

In one or more embodiments, the change of the position and/or the engagement with and/or disengagement from the ground of the at least one auxiliary wheel is controllable by one or more control modules configured to evaluate one or more control parameters and to determine, based on an assessed operating condition of the bicycle, whether and how the auxiliary wheel is actuated.

In one or more embodiments the adaptive stabilizing system the change of the position of the at least one auxiliary wheel is controllable by one or more control modules using control parameters that are input by the rider of the bicycle.

In one or more embodiments the adaptive stabilizing system control parameters comprise sensor-derived inputs including cadence or cycle rate of pedaling, presence of skidding, braking, mechanical malfunction, direction of pedaling, tilting angle α of the vehicle, speed of the vehicle, or combinations thereof, wherein said parameters are processed individually or in combination and selectively weighted depending on the detected riding condition. In one or more embodiments the adaptive stabilizing system, braking of the bicycle via engaging brakes for main wheels of the vehicle is provided as an input that may actuate movement of at least one auxiliary wheel for engagement of the at least one auxiliary wheel with the ground surface for stabilizing the bicycle.

In one or more embodiments the adaptive stabilizing system comprises a limiter to control and limit a range of linear and/or angular motion of the at least one auxiliary wheel along at least one of the Y-axis, X-axis and Z-axis with respect to the central plane of the bicycle such that a minimum selected distance between the at least one auxiliary wheel and any part of the bicycle frame is maintained as the at least one auxiliary wheel is moved between one or more positions.

In one or more embodiments the adaptive stabilizing system the one or more control modules are configured for operation in at least two operating states corresponding to different riding conditions, wherein transitions between said operating states are dynamically determined based on evaluated sensor data. In some instances this includes at least a higher speed and a lower speed operating state. The change of the position of the at least one auxiliary wheel is controllable by one or more control modules configured to evaluate one or more control parameters and to determine, based on an assessed operating condition of the bicycle, whether and how the auxiliary wheel is actuated for each of the at least two operating states.

In one or more embodiments the adaptive stabilizing system comprises at least one releasable coupling mechanism to releasably couple the steering movement of the bicycle to the stabilizing system.

In one or more embodiments the releasable coupling mechanism is a clutch.

Another aspect of the present disclosure relates to a method of stabilizing a bicycle using dual-speed adaptive control logic, the method comprising providing the bicycle with an adaptive stabilizing system comprising one or more control modules for at least one auxiliary wheel mounted to a location positioned on a front of the bicycle near the steering device of the bicycle and wherein the at least one auxiliary wheel is configured to move between positions where the at least one auxiliary wheel engages and disengages with a ground surface while the bicycle moves along the ground surface.

In one or more embodiments the one or more control modules are responsive to one or more automatic or manual inputs for adjusting the position of the at least one auxiliary wheel as the bicycle travels across the ground surface at one or more speeds.

In one or more embodiments automatically adapting engagement and/or disengagement of the at least one auxiliary wheel with the ground surface is by way of automatically switching between a first control mode and a second control mode for the adaptive stabilization system, by providing the one or more controllers with a first control mode for use of the bicycle in a high-speed mode with a first set of control parameters and a second control mode for use of the bicycle in a low-speed mode with a second set of control parameters such that the one or more controllers are configured for automatically adapting engagement and/or disengagement of the at least one auxiliary wheel with the ground surface for use and/or stabilization of the bicycle.

In one or more embodiments using one or more control parameters, the driver's interaction with the stabilizing system, or a combination thereof to trigger the stabilizing system to enter a safe position, said safe position being characterized in that each auxiliary wheel of the at least one auxiliary wheel is engaged with the ground surface and main wheels of the bicycle and each wheel of the auxiliary wheels are positioned substantially straight with respect to a longitudinal direction of the bicycle.

Another aspect of the present invention relates to a retrofit adaptive stabilization assembly for a bicycle comprising a stabilization chassis for mounting to a front section of a bicycle comprising a pair of auxiliary wheels for position on opposing sides of a front wheel of the bicycle; and a control module in communication with the auxiliary wheels, wherein the auxiliary wheels are configured to move between one or more positions wherein the wheels engage or disengage with a ground surface as the bicycle traverses the ground surface at one or more speeds, and wherein the auxiliary wheels are configured to move between the one or more positions in response to one or more control inputs automatically or manually received and wherein the one or more control inputs comprise cadence of pedaling, cycle rate of pedaling, presence of skidding, braking, mechanical malfunction, direction of pedaling, change in direction of pedaling, tilting angle α of the bicycle, speed of the bicycle and combinations thereof.

In one or more embodiments, the at least one auxiliary wheels is mounted to the bicycle and configured to move between positions by moving up and down along a Y-axis, left and right along an X-axis, closer to the bicycle or away from the bicycle along a Z-axis or by changing an angle along one of the Y, X, or Z axes with respect to a central plane of the bicycle.

In one or more embodiments, the control module is configured for operation in at least two operating states, a low speed operating state and a high speed operating state, and wherein the change of the position of the at least one auxiliary wheel correspond to transitions between said operating states which are dynamically determined based on evaluated sensor data.

In one or more embodiments the retrofit adaptive stabilization assembly further comprises one or more sensors for detecting and providing one or more control inputs to the controller.

In one or more embodiments the retrofit adaptive stabilization assembly further comprises one or more gearing mechanisms, linkages, wishbones, ball joints, hydraulic rods, momentum levers transmitters, springs, cogs, chains, cables, inertial sensors and combinations thereof to provide the auxiliary wheels and control module configured to adaptive stabilization of the bicycle.

Yet another aspect of the present disclosure relates to a brake activated adaptive stabilization assembly for a bicycle wherein auxiliary wheels provided on a front fork of a bicycle are actuated to move along at least one of an X, Y and Z axis in a linear or angular manner to engage a ground surface to stabilize the bicycle upon user braking of the bicycle.

### BRIEF DESCRIPTION OF THE DRAWINGS

FIGS. 1a, b and c show perspective views of a vehicle according to one embodiment of the invention (FIG. 1a), of a semi closed cabin (FIG. 1b) and of a steering unit of a vehicle with a stabilizing system according to the invention (FIG. 1c).

FIG. 2a illustrates mechanical articulations of two side suspensions on which the auxiliary wheels will be assembled.

FIG. 2b shows a mechanical stability control unit according to one embodiment of the invention.

FIG. 2c gives a schematic view of a part of a mechanical stability control unit with a handlebar. That describes the safety braking trigger engagement routing.

FIG. 2d shows part of a mechanical coupling device to pick up and transmit movement of the pedaling.

FIGS. 3a, b, c and d show a vehicle according to one embodiment of the invention in different control modes.

FIG. 4a shows a vehicle according to one embodiment of the invention in a safe position.

FIGS. 4b, c, d and e are top (FIGS. 4b and d) and frontal (FIGS. 4c and e) views of a vehicle according to one embodiment of the invention in a laterally stable position.

### DETAILED DESCRIPTION

The figures depict possible embodiments of the invention or illustrate parts thereof, which will be explained in the following description. The invention is, however, not limited to the embodiments as shown in the figures.

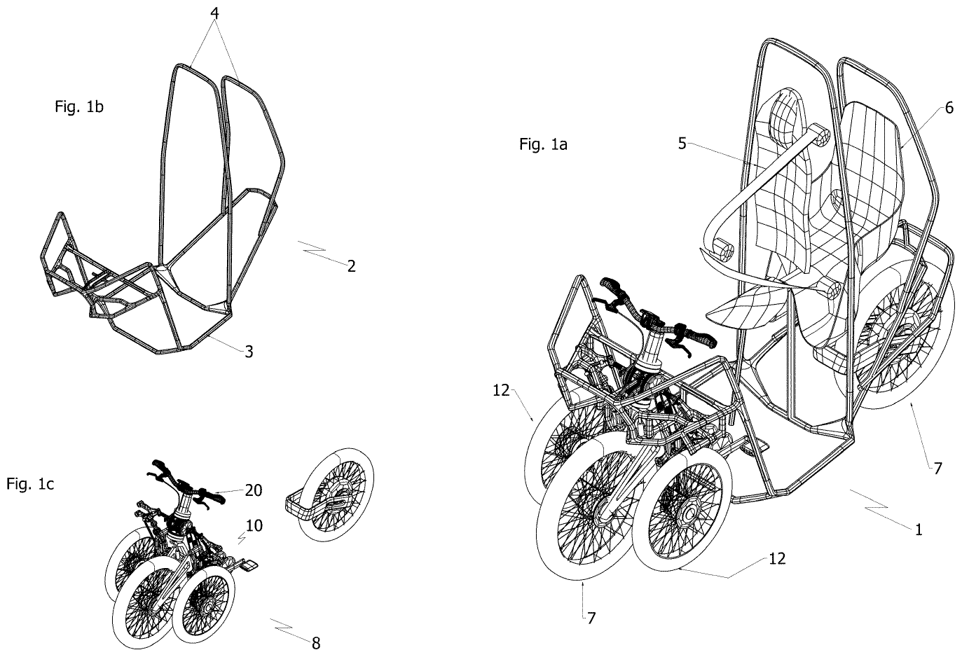

FIG. 1a is a perspective view of a vehicle 1 according to the invention comprising two main wheels 7 and two auxiliary wheels 12, each one of them on a different side of the main wheels. Both auxiliary wheels 12 are not engaged with the ground, but in a lifted position. Also visible is the semi-closed cabin 2 on the top of the vehicle and a main seat 5 (for the driver) and an auxiliary seat 6 (for a co-driver, typically a child).

FIG. 1b shows a perspective view of the semi-closed cabin 2 which comprises a frame 3, designed to provide the structural integrity of the vehicle and protection means 4, designed to protect passengers in case of, for example, an accident.

FIG. 1c is a perspective view of the steering unit 8 of a vehicle 1 comprising the stabilizing system 10 according to one embodiment of the invention. One main wheel 7 of the vehicle is visible and is supplemented by one auxiliary wheel 12 on each side, both of which are in a lifted state, i.e., not engaged with the ground.

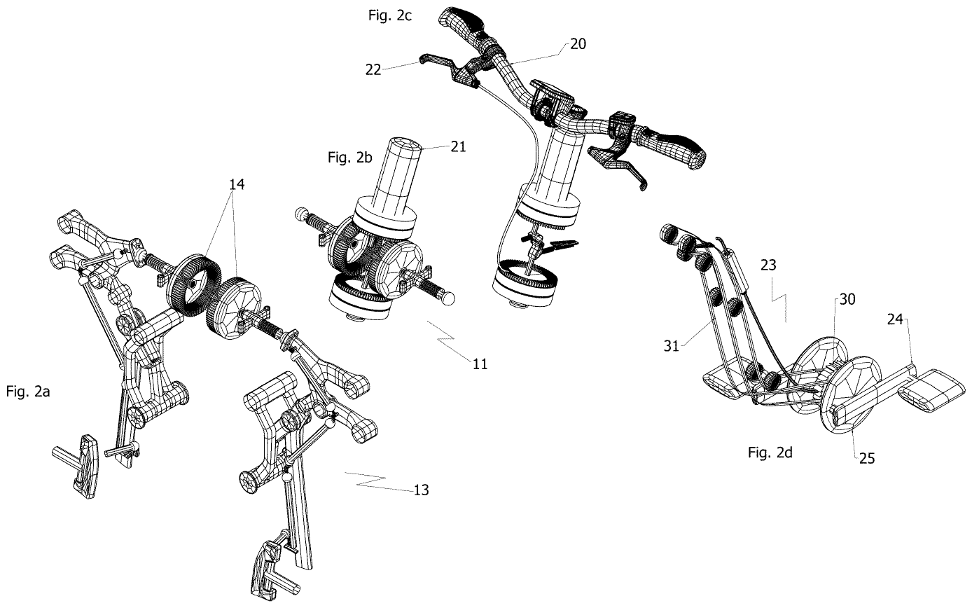

In FIG. 2a mechanical articulations 13 of the auxiliary wheels 12 that allow for the movement of the auxiliary wheels 12 are depicted. They allow for a movement of the auxiliary wheels 12 in y-axis (up and down), z-axis (closer to the vehicle or more away from the vehicle) and changing the angle of the plane in which are situated the auxiliary wheels 12 with respect to the central plane of the vehicle 1.

FIG. 2b shows a mechanical stability control unit 11 which is employed to couple and transmit the steering movement of the handlebar 20 to the mechanical articulations 13 of the auxiliary wheels 12. A rotation of the stem 21 is transmitted through the gearing mechanism 14 to the mechanical articulations 13 which mechanical articulations 13 in turn are drivable to move an auxiliary wheel 12 mounted to them. As can be seen from FIG. 2c, a brake lever 22 of the vehicle is connected to the stability control unit 11 to facilitate engagement and/or disengagement of the stabilizing system based on brake engagement as a control parameter.

According to FIG. 2d, a mechanical coupling device 30 may be used to pick up and transmit the movement of the pedaling. Transmission means 31 connect the mechanical coupling device 30 to the stabilizing system, through which transmission means 31, the auxiliary wheels 12 can be lifted and disengaged from the ground when the driver starts pedaling, while the shown ratchet-like mechanism ensures that only the pedaling movement in a first direction, preferably a forward direction, is transmitted and no auxiliary wheels 12 are accidentally lowered should the driver decide to pedal in a second direction, preferably a backwards direction, during the ride. The pedals are positioned above the platform in the embodiments illustrated for superior ease for the user. The assembly is also front mounted to the vehicle.

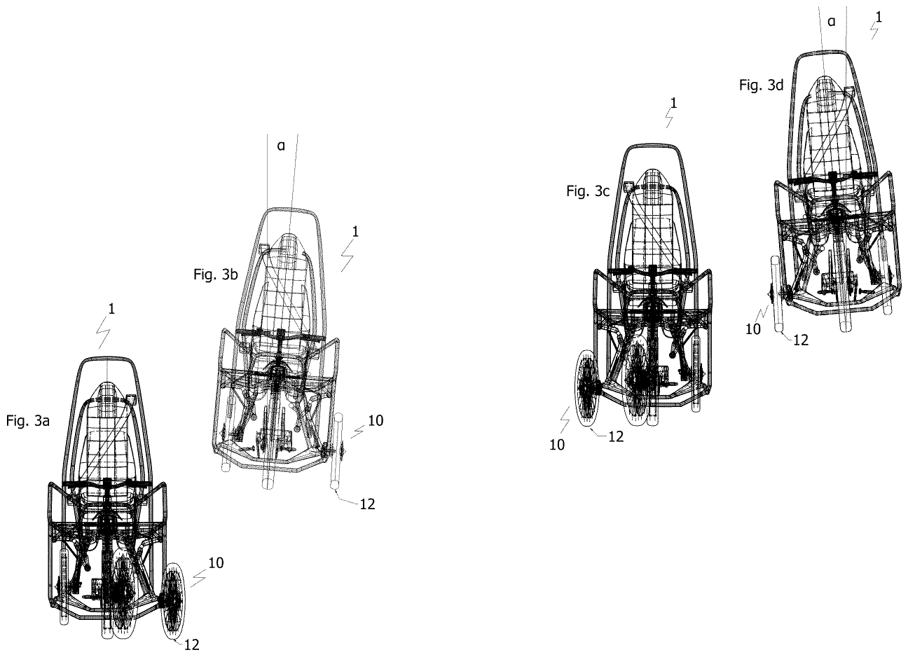

On FIGS. 3a, 3b, 3c and 3d, different modes of operation can be seen. FIGS. 3a and 3c show a vehicle 1, comprising the stabilizing system 10 according to one embodiment of the invention, in a low-speed mode, wherein the vehicle 1 makes a turn and one auxiliary wheel 12 is driven to lower and engage with the ground but with little to no tilting of the vehicle, i.e. a is essentially zero. FIGS. 3b and 3d show the same vehicle 1 in a high-speed mode, wherein said vehicle 1 is tilted (i.e. |a|>0) to facilitate the turn and one of the auxiliary wheels 12 is driven to lower and engage with the ground in order to support the turning of the vehicle 1 and add to the stability.

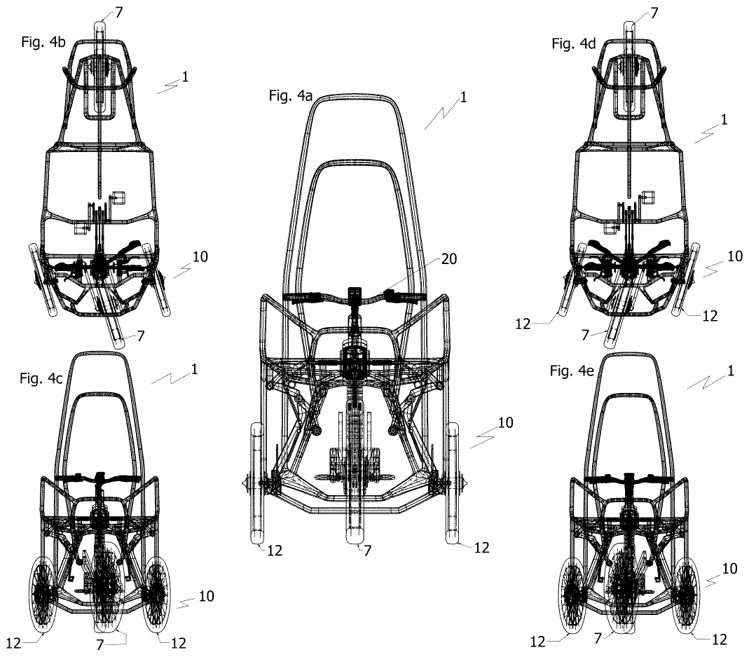

In an advantageous way, the stabilizing system uses suitable means to detect whether a driver is engaged with the handle bar 20 and in case the driver is not engaged with the handle bar 20 any longer or, for example, in case of a vehicle malfunction, the stabilizing system is triggered to go into a safe position (FIG. 4a). In the safe position, all auxiliary wheels 12 are engaged with the ground, the vehicles main wheels 7 and all auxiliary wheels 12 are positioned essentially straight to the longitudinal direction of the vehicle and no side tilt is present, i.e., a is essentially zero.

FIGS. 4b, 4c, 4d and 4e depict a vehicle 1 comprising the stabilizing system according to one embodiment of the invention in a resting position in a frontal and top view, respectively. All auxiliary wheels 12 of the depicted vehicle 1 are engaged with the ground so that the vehicle 1 is laterally stable while not in motion, i.e., resting. In the depicted resting position, all auxiliary wheels 12 as well as the front wheel 7 are turned, however this is not required for the vehicle to remain stable in a resting position. Instead, the wheels could be positioned essentially straight like in the safe position.

Such a position may as well be the starting position for driving, wherein a driver takes place in the laterally stable vehicle 1 and starts pedaling, wherein any or all of the auxiliary wheels 12 are lifted and disengaged from the ground based on, for example, the pedaling movement or the vehicle speed.

It is also contemplated and within this disclosure that one or more combinations described herein form a retrofit adaptive stabilization assembly for a bicycle. That is, a stabilization chassis according to one or more embodiments described herein is provided for mounting to a front section of a bicycle. The chassis comprising a pair of auxiliary wheels for positioning on opposing sides of a front wheel of the bicycle. The chassis can then be provided with a control module according to any one of the embodiments described herein such that the chassis and control module are in communication during use. The control module is in communication with the auxiliary wheels. As with one or more embodiments described herein, the auxiliary wheels are configured to move between one or more positions wherein the wheels engage or disengage with a ground surface as the bicycle traverses the ground surface at one or more speeds. The auxiliary wheels are configured to move between the one or more positions in response to one or more control inputs automatically or manually received and wherein the one or more control inputs comprise cadence of pedaling, cycle rate of pedaling, presence of skidding, braking, mechanical malfunction, direction of pedaling, change in direction of pedaling, tilting angle α of the bicycle, speed of the bicycle and combinations thereof.

To allow for the assembly to a retrofit adaptive stabilization assembly the assembly can be further comprising one or more gearing mechanisms, linkages, wishbones, ball joints, hydraulic rods, momentum levers transmitters, springs, cogs, chains, cables, inertial sensors and combinations thereof to provide the auxiliary wheels and control module configured to adaptive stabilization of the bicycle and to allow the assembly to safely secure to the bicycle.

It is also contemplated and within this disclosure that one or more combinations described herein form a modular stabilization assembly. That is, in one or more embodiments, the assembly is provided in a modular form for easy assembly and disassembly as well as ease of transport for shipping.

Of course, this brief description contains only the most important concepts of the present invention and is not meant to be a comprehensive disclosure. A skilled person will understand that many additional details can be added to the invention, without departing from the general inventive idea. Also, any details known from the prior art, namely in connection with the general structure of bicycles, have not been described but it will be understood that these elements are well known to a skilled person.

What is claimed:

1. An adaptive stabilizing system for a bicycle comprising:
at least one auxiliary wheel mounted to a location positioned on a front of the bicycle
near the steering device of the bicycle and configured to move between positions for use with respect to the bicycle; and
one or more control modules operably coupled to the at least one auxiliary wheel and configured to actuate movement of the at least one auxiliary wheel between positions for use and wherein the one or more control modules are responsive to automatic or manual inputs, and
wherein the at least one auxiliary wheel is mounted to the bicycle and configured to move between positions along one or more translational and/or rotational degrees of freedom relative to the bicycle such that the at least one auxiliary wheel is configured to automatically or manually adapt to engage or disengage a ground surface during use of the bicycle for selected stabilization of the bicycle during use or when stationary.

2. The adaptive stabilizing system according to claim 1, further comprising two or more auxiliary wheels and wherein each auxiliary wheel of the two or more auxiliary wheels is independently operably to change position with respect to the bicycle and/or engage with or disengage the ground surface.

3. The adaptive stabilizing system according to claim 1, wherein the change of the position of the at least one auxiliary wheel is controllable by one or more control modules configured to evaluate one or more control parameters and to determine, based on an assessed operating condition of the bicycle, whether and how the at least one auxiliary wheel is actuated.

4. The adaptive stabilizing system according to claim 1, wherein the change of the position of the at least one auxiliary wheel is controllable by one or more control modules using control parameters that are input by the rider of the bicycle.

5. The adaptive stabilizing system according to claim 3, wherein the control parameters comprise sensor-derived inputs including cadence or cycle rate of pedaling, presence of skidding, braking, mechanical malfunction, direction of pedaling, tilting angle α of the vehicle, speed of the vehicle, or combinations thereof, wherein said parameters are processed individually or in combination and selectively weighted depending on the detected riding condition.

6. The adaptive stabilizing system according to claim 3, wherein braking of the bicycle via engaging brakes for main wheels of the vehicle is provided as an input that may actuate movement of at least one auxiliary wheel for engagement of the at least one auxiliary wheel with the ground surface for stabilizing the bicycle.

7. The adaptive stabilizing system according to claim 1, and comprising a limiter to control and limit a range of linear and/or angular motion of the at least one auxiliary wheel along at least one or more translational and/or rotational degrees of freedom relative to the bicycle such that a minimum selected distance between the at least one auxiliary wheel and any part of the bicycle frame is maintained as the at least one auxiliary wheel is moved between one or more positions.

8. The adaptive stabilizing system according to claim 1, wherein the one or more control modules are configured for operation in at least two operating states corresponding to different riding conditions, wherein transitions between said operating states are dynamically determined based on evaluated sensor data.

9. The adaptive stabilizing system according to claim 1, comprising at least one releasable coupling mechanism to releasably couple the steering movement of the bicycle to the stabilizing system or wherein a releasable coupling mechanism is a clutch.

10. The adaptive stabilizing system according to claim 1 wherein the control module is further configured to determine that auxiliary wheel engagement is not required despite the presence of one or more control parameters.

11. A method of stabilizing a bicycle using dual-speed adaptive control logic, the method comprising:
providing the bicycle with an adaptive stabilizing system comprising one or more control modules for at least one auxiliary wheel mounted to a location positioned on a front of the bicycle near the steering device of the bicycle and wherein the at least one auxiliary wheel is configured to move between positions where the at least one auxiliary wheel engages and disengages with a ground surface while the bicycle moves along the ground surface.

12. The method of claim 11 wherein the one or more control modules are responsive to one or more automatic or manual inputs for adjusting a position of the at least one auxiliary wheel as the bicycle travels across the ground surface at one or more speeds.

13. The method of claim 11, and automatically adapting engagement and/or disengagement of the at least one auxiliary wheel with the ground surface by way of automatically switching between a first control mode and a second control mode for the adaptive stabilization system, by providing the one or more controllers with a first control mode for use of the bicycle in a high-speed mode with a first set of control parameters and a second control mode for use of the bicycle in a low-speed mode with a second set of control parameters such that the one or more controllers are configured for automatically adapting engagement and/or disengagement of the at least one auxiliary wheel with the ground surface for use and/or stabilization of the bicycle.

14. The method of claim 11, and using one or more control parameters, the driver's interaction with the stabilizing system, or a combination thereof to trigger the stabilizing system to enter a safe position, said safe position being characterized in that each auxiliary wheel of the at least one auxiliary wheel is engaged with the ground surface and main wheels of the bicycle and each wheel of the auxiliary wheels are positioned substantially straight with respect to a longitudinal direction of the bicycle.

15. A retrofit adaptive stabilization assembly for a bicycle comprising:
a stabilization chassis for mounting to a front section of a bicycle comprising a pair of auxiliary wheels for position on opposing sides of a front wheel of the bicycle; and
a control module in communication with the auxiliary wheels,
wherein the auxiliary wheels are configured to move between one or more positions wherein the wheels engage or disengage with a ground surface as the bicycle traverses the ground surface at one or more speeds, and
wherein the auxiliary wheels are configured to move between the one or more positions in response to one or more control inputs automatically or manually received and wherein the one or more control inputs comprise cadence of pedaling, cycle rate of pedaling, presence of skidding, braking, mechanical malfunction, direction of pedaling, change in direction of pedaling, tilting angle α of the bicycle, speed of the bicycle and combinations thereof.

16. The retrofit adaptive stabilization assembly of claim 15, wherein the at least auxiliary wheels is mounted to the bicycle and configured to move between positions by moving up and down along one or more translational degrees of freedom relative to the bicycle or by changing an angle along one or more rotational degrees of freedom relative to the bicycle.

17. The retrofit adaptive stabilization assembly of claim 15 wherein the control module is configured for operation in two modes, a low speed mode and a high speed mode, and wherein the change of the position of the at least one auxiliary wheel is controllable by one or more control modules configured to evaluate one or more control parameters and to determine, based on an assessed operating condition of the bicycle, whether and how the auxiliary wheel is actuated for each of the two modes of operation.

18. The retrofit adaptive stabilization assembly of claim 15 and further comprising one or more sensors for detecting and providing one or more control inputs to the controller.

19. The retrofit adaptive stabilization assembly of claim 15 and further comprising one or more gearing mechanisms, linkages, wishbones, ball joints, hydraulic rods, momentum levers transmitters, springs, cogs, chains, cables, inertial sensors and combinations thereof to provide the auxiliary wheels and control module configured to adaptive stabilization of the bicycle.

20. The stabilization assembly of claim 1 and wherein the assembly is a brake activated adaptive for a bicycle and wherein auxiliary wheels provided on a front fork of a bicycle are actuated to move along at least one or more translational and/or rotational degrees of freedom relative to the bicycle in a linear or angular manner to engage a ground surface to stabilize the bicycle upon user braking of the bicycle.
